(19) United States
(12) Patent Application Publication
(10) Pub. No.: US 2025/0298671 A1
(43) Pub. Date: Sep. 25, 2025

(54) METHOD AND DEVICE WITH TASK SET FORMATION FOR INFERENCE OPERATION OF NEURAL NETWORK MODEL

(71) Applicants: Samsung Electronics Co., Ltd., Suwon-si (KR); Research & Business Foundation SUNGKYUNKWAN UNIVERSITY, Suwon-si (KR)

(72) Inventors: Gyeongmin LEE, Suwon-si (KR); Hwansoo HAN, Suwon-si (KR); Sungin HONG, Suwon-si (KR)

(73) Assignees: Samsung Electronics Co., Ltd., Suwon-si (KR); Research & Business Foundation SUNGKYUNKWAN UNIVERSITY, Suwon-si (KR)

(21) Appl. No.: 19/034,287

(22) Filed: Jan. 22, 2025

(30) Foreign Application Priority Data
Mar. 21, 2024 (KR) 10-2024-0039192
Jun. 17, 2024 (KR) 10-2024-0078369

(51) Int. Cl. G06F 9/50; G06F 9/38; G06F 9/48; G06N 5/04

(52) U.S. Cl. CPC G06F 9/5066; G06F 9/3885; G06F 9/4887; G06N 5/04

(57) ABSTRACT

A device includes a processor configured to obtain a reference task set representing a result of dividing instructions for an inference operation of a neural network model into tasks, which are execution units of a processing device, determine an additional task set based on the obtained reference task set, based on the processing device executing a first inference operation and a second inference operation in parallel as the reference task set and the additional task set through multi-processes, determine a predicted runtime of at least one inference operation of the first inference operation or the second inference operation, adjust the determined additional task set, and based on the predicted runtime being less than or equal to a target runtime, associate the determined additional task with the target runtime.

### CROSS-REFERENCE TO RELATED APPLICATIONS

This application claims the benefit under 35 USC § 11 (a) of Korean Patent Application No. 10-2024-0039192, filed on Mar. 21, 2024 and 10-2024-0078369, filed on Jun. 17, 2024, in the Korean Intellectual Property Office, the entire disclosures of which are incorporated herein by reference for all purposes.

### BACKGROUND

### 1. Field

The following description relates to technology for determining a result of dividing instructions for an inference operation of a deep learning model (e.g., a neural network model).

### 2. Description of Related Art

Compilers translate source code written in a programming language to machine code. A compiler may analyze code and generate machine code according to an analysis result. To optimize the efficiency of machine code output from the compiler, numerous compiler optimizations may be applied. Compiler optimization generally reduces execution speed of a program and/or minimizes the size of memory used by a program while the program is being executed, for example.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of determining a task set for an inference operation of a neural network model is performed by an electronic device, and the method includes: applying a compiler to a neural network model to obtain a reference task set, the reference task set representing a result of dividing, by the compiler, instructions for an inference operation of the neural network model into tasks, wherein tasks are execution units of a processing device; determining an additional task set based on the obtained reference task set; based on the processing device executing, in parallel through multi-processes, a first inference operation as the reference task set and a second inference operation as the additional task set through multi-processes, determining a predicted runtime of a given inference operation of the first inference operation or the second inference operation; when the predicted runtime exceeds a target runtime set for the given inference operation, adjusting the determined additional task set; and when the predicted runtime is less than or equal to the target runtime, associating the determined additional task set with the target runtime.

The method may further include: obtaining a first inference request, a second inference request, and a deadline for the first inference request; and based on the target runtime meeting the obtained deadline, causing the processing device to execute, through multi-process, an inference operation corresponding to the first inference request as the reference task set and execute an inference operation corresponding to the second inference request as the additional task set.

The adjusting of the determined additional task set may include: selecting a task having a longest runtime from among tasks included in the additional task set; partitioning the selected task into a set of tasks; and determining, among the reference task set, the additional task set in which the selected task is replaced with the set of tasks.

The partitioning of the selected task into the set of tasks may include: partitioning the selected task into a first task including a thread block among thread blocks included in the selected task and a second task including remaining thread blocks among the thread blocks.

The partitioning of the selected task into the set of tasks may include: obtaining, for each task among tasks included in the reference task set, task information related to execution of the corresponding task, the task information including a register usage, a shared memory usage, a number of thread blocks, or block occupancy of the processing device; and partitioning the selected task into the set of tasks based on task information of the set of tasks.

The adjusting of the determined additional task set may include: selecting a task having a longest runtime from among runtimes of tasks included in the additional task set; obtaining a changed task by inserting an instruction that causes, in the processing device, context switching into the selected task; and determining the additional task set in which the selected task is replaced with the changed task.

The obtaining of the changed task may include: inserting an instruction that causes context switching into each of thread blocks included in the selected task.

The obtaining of the changed task may include: regarding operator fusions performed using the compiler, obtaining operator fusion information including information on a gain of each operator fusion and on operators before and after each operator fusion; and canceling operator fusion having a least gain among gains of operator fusions performed in each thread block included in the selected task, based on the obtained operator fusion information.

The adjusting of the determined additional task set may include: selecting a task having a longest runtime from among runtimes of tasks included in the additional task set; performing partitioning of the selected task based on a number of thread blocks included in the selected task exceeding a maximum number of thread blocks simultaneously executable by the processing device; and performing instruction insertion or operator fusion cancelation on the selected task based on the number of thread blocks included in the selected task being less than or equal to the maximum number of thread blocks simultaneously executable by the processing device.

The determining of the additional task set may include: determining a result of changing at least a portion of instructions as the additional task set, wherein the portion of instructions has partitioned at least one task among tasks included in the reference task set or has performed instruction insertion or operator fusion cancelation on the at least one task.

The method may further include: determining a reference runtime required for the processing device to perform, through a single process, a single inference operation as the obtained reference task set; and obtaining a target runtime indicating a permissible range of a runtime increased compared to the reference runtime based on the reference runtime and a target ratio.

The determining of the predicted runtime may include: predicting a first time length from a start time of the first inference operation to a completion time of the first inference operation or predicting a second time length from a start time of the second inference operation to a completion time of the second inference operation.

The method may further include: updating the predicted runtime based on the adjusted additional task set; repeating adjusting the additional task set and updating the predicted runtime based on the updated predicted runtime exceeding the target runtime; and stopping adjusting the additional task set and updating the predicted runtime, and associating the additional task set with the target runtime, in response to the updated predicted runtime being less than or equal to the target runtime.

The method may further include: obtaining candidate target runtimes; determining, for each of the candidate target runtimes, a candidate additional task set having a predicted runtime that is less than or equal to a corresponding candidate target runtime; and associating the candidate additional task set determined for the candidate target runtime with each candidate target runtime.

The method may further include: determining candidate additional task sets respectively associated with the candidate target runtimes and subsequently obtaining a first inference request, a second inference request, and a deadline for the first inference request; selecting an additional task set associated with a target runtime that meets the obtained deadline from among the candidate target runtimes; and transmitting information related to the selected additional task set to the processing device.

The transmitting of the information related to the selected additional task set to the processing device may include: causing the processing device to process, through multi-processes, an inference operation corresponding to the first inference request as the reference task set and an inference operation corresponding to the second inference request as the selected additional task set.

A non-transitory computer-readable storage medium may store instructions that, when executed by a processor, cause the processor to perform any of the methods.

In another general aspect, an electronic device includes: one or more processors; and a memory storing instructions configured to cause the one or more processors to: apply compiler to a neural network model to obtain a reference task set, the reference task set representing a result of dividing, by the compiler, instructions for an inference operation of the neural network model into tasks, wherein tasks are execution units of a processing device; determine an additional task set based on the obtained reference task set; based on the processing device executing, in parallel through multi-processes, a first inference operation as the reference task set and a second inference operation as the additional task set, determine a predicted runtime of a given inference operation of the first inference operation or the second inference operation; when the predicted runtime exceeds a target runtime set for the given inference operation, adjust the determined additional task set; and when the predicted runtime is less than or equal to the target runtime, associate the determined additional task set with the target runtime.

The instructions may be further configured to cause the one or more processors to: select a task having a longest runtime from among tasks included in the additional task set; partition the selected task into a set of tasks; and determine, among the reference task set, the additional task set in which the selected task is replaced with the set of tasks.

The instructions may be further configured to cause the one or more processors to: select a task having a longest runtime from among runtimes of tasks included in the additional task set; obtain a changed task by inserting an instruction that causes, in the processing device, context switching into the selected task; and determine the additional task set in which the selected task is replaced with the changed task.

Other features and aspects will be apparent from the following detailed description, the drawings, and the claims.

### BRIEF DESCRIPTION OF THE DRAWINGS

FIG. 1 illustrates an example method of determining a task set for an inference operation of a deep learning model, according to one or more embodiments.

FIG. 2 illustrates an example of obtaining a reference task set and an additional task set, according to one or more embodiments.

FIG. 3 illustrates an example of a result of dividing instructions for an inference operation into multiple tasks, according to one or more embodiments.

FIG. 4 illustrates an example of an operation of partitioning a task, according to one or more embodiments.

FIG. 5 illustrates an example of executing inference operations according to task partitioning, according to one or more embodiments.

FIG. 6 illustrates an example of operator fusion cancelation or command insertion, according to one or more embodiments.

FIG. 7 illustrates an example of executing inference operations according to operator fusion cancelation, according to one or more embodiments.

FIG. 8 illustrates an example of obtaining additional task sets corresponding to candidate target runtimes and selecting a task set for an inference request, according to one or more embodiments.

FIG. 9 illustrates an example of a runtime of inference operations in a case in which a processing device executes inference operations in multi-processes using an additional task set mapped to various target runtimes, according to one or more embodiments.

FIG. 10 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

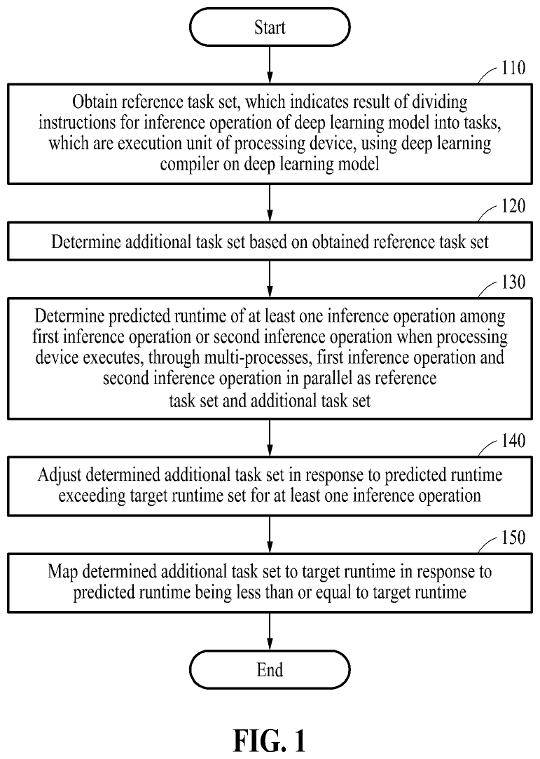

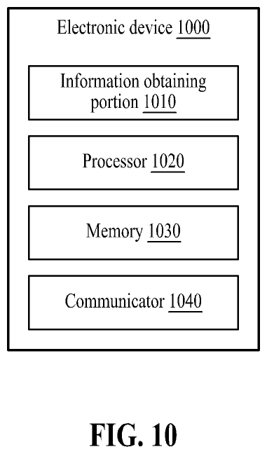

FIG. 1 illustrates an example of determining a task set for an inference operation of a deep learning model, according to one or more embodiments. The method of FIG. 1 is performed by an electronic device or computing device, an example of which is described with reference to FIG. 10.

In operation 110, the electronic device may obtain a reference task set, which indicates a result of dividing instructions for an inference operation of the deep learning model into tasks. A task is an execution unit of a processing device, and the reference task set may be obtained using a deep learning compiler on the deep learning model (e.g., a neural network model). The deep learning compiler (or just “compiler”) may be capable of compiling source code of a deep learning model to generate an output for performing inference of the deep learning model.

The deep learning model may be a type of machine learning model and may include a neural network including an input layer, at least one hidden layer, and an output layer.

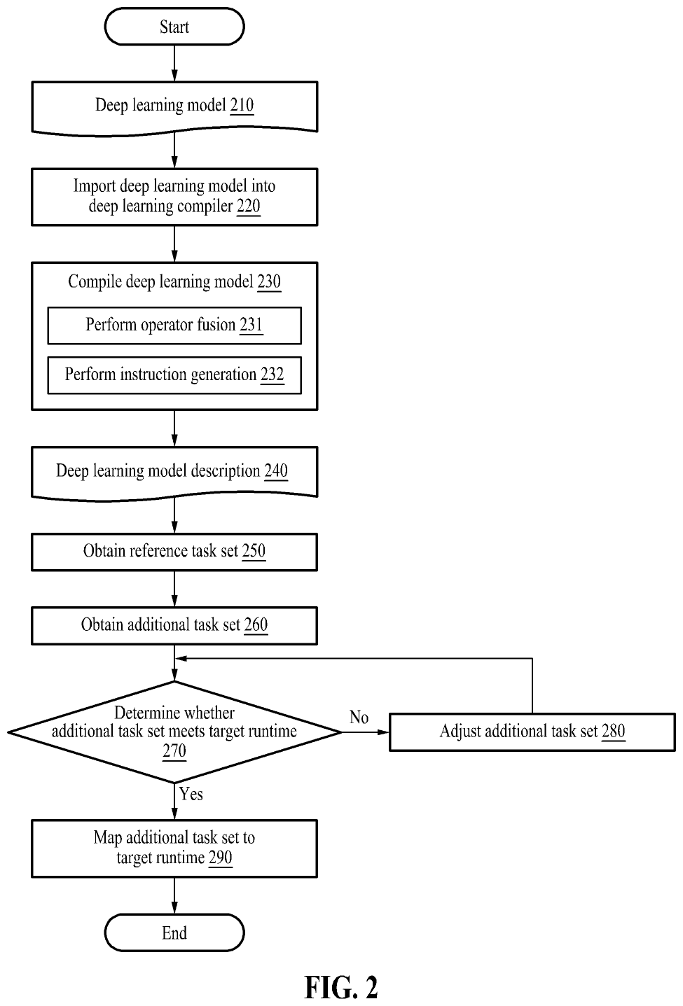

The deep learning compiler may be software that generates the instructions for an inference operation of the deep learning model and/or performs optimization of the instructions. For example, the deep learning compiler may perform operation fusion and/or instruction generation. An operation of the deep learning compiler is described with reference to FIG. 2.

A task may be an execution unit of a processing device (e.g., a central processing unit (CPU), a graphics processing unit (GPU), or a neural processing unit (NPU)) and may be a unit that is called/referenced by the processing device as a target of execution. Due to limitations in resources of the processing device, the processing device may call and execute a task that is part of the instructions rather than executing the instructions simultaneously. The resources of the processing device may include internal memory (e.g., a register or a cache) and/or a processing element (e.g., a processor or a core). For example, the processing device may allocate at least a portion of the resources of the processing device to a task when starting execution of a determined task, maintain the portion of the resources of the processing device allocated to the task until the execution of the task is completed, and deallocate the resources when the execution of the task is completed.

The instructions for an inference operation of the deep learning model may be divided into tasks, and a task set may include the result of dividing the instructions into tasks. The formation of the task set may directly affect the runtime of an inference operation. For example, the processing device may execute an inference operation of the deep learning model as a second task set with a less runtime compared to when executing the inference operation of the deep learning model with a first task set.

As described below with reference to FIG. 2, the task set is not limited to being defined only as a result of dividing instructions into tasks, and the task set may also be defined as fusion of operators (also referred to as “operator fusion”) indicated by an instruction included in each task or as operator fusion cancelation (e.g., operator fission).

The form of the task set may affect the runtime of each inference operation not only when the processing device executes a single inference operation in a single process, but also when the processing device executes multiple inference operations in multi-processes. When the processing device processes inference operations in multi-processes, tasks of the inference operations may share the resources of the processing device through temporal sharing and/or spatial sharing. Multi-processes may be, for example processes managed by a service (e.g., the NVIDIA Multi-Process Service (MPS)) to allow the processes to execute instructions on a GPU at the same time. The MPS may be a binary-compatible implementation of the CUDA application programming interface (API) that transparently enables cooperative multi-process CUDA applications to execute respective kernels, for example, on the same GPU.

Temporal sharing is a manner by which the resources of the processing device are allocated to at least a portion (e.g., at least one task of a first inference operation) of the first inference operation and the portion of the first inference operation is executed during a first time period, and the resources of the processing device are allocated to at least a portion (e.g., at least one task of a second inference operation) of the second inference operation and the portion of the second inference operation is executed during a second time period following the first time period.

Spatial sharing is a manner in which when a portion of the resources of the processing device is allocated to at least a portion (e.g., at least one task of the first inference operation) of the first inference operation and another portion of the resources of the processing device is allocated to at least a portion (e.g., at least one task of the second inference operation) of the second inference operation, the portion of the first inference operation and the portion of the second operation are executed simultaneously.

Processing inference operations in multi-processes by the processing device may indicate whether the processing device should execute the inference operations through co-scheduling or co-location by using a scheduler.

The scheduler of the processing device may be software that controls allocation and/or deallocation of the resources of the processing device and context switching between inference operations to which the same resources are allocated, when executing the inference operations in multi-processes.

The scheduler may control the execution of the inference operations in multi processes based on a task set in which are divided the instructions of the inference operations and an instruction that causes context switching included in each task.

For example, when executing the inference operations, the scheduler may insert tasks divided according to a task set corresponding to each inference operation into a task queue. The processing device may obtain the first task selected by the scheduler from the task queue, allocate resources for the first task, and execute the first task using the allocated resources. In response to completion of the first task (or a thread block of the first task), the scheduler may deallocate the allocated resources and select and execute a second task. Since the scheduler may control the processing device to execute instructions on a task basis, an execution process of operations in multi-processes may vary depending on the division of tasks.

For example, the scheduler may allocate the same resources to inference operations (e.g., tasks or thread blocks) to be shared. When the scheduler allocates the same resource to tasks, the scheduler may cause the processing device to execute the first task among the tasks. When the processing device executes an instruction that causes context switching included in the first task while executing the first task, the scheduler may cause the processing device to switch from the first task to the second task. Since the scheduler may control context switching according to the instruction that causes context switching included in a task, the execution process of operations in multi-processes may vary depending on the instruction included in a task.

For example, the processing device may process the first inference operation and the second inference operation in parallel through multi-processes, or may execute the first inference operation as the first task set and execute the second inference operation as the second task set. The first task set may affect the runtime of both the first inference operation and the second inference operation. Likewise, the second task set may affect the runtime of the first inference operation and the second inference operation. The first inference operation and the second inference operation may have different priorities and/or different deadlines. When the priority of the first inference operation is higher than the priority of the second inference operation or when a deadline is set for the first inference operation, the runtime of the first inference operation may be controlled by adjusting a task set used for execution of the second inference operation.

Since the task set may only include a result of dividing instructions and/or a result of operator fusions and not change at least one of operations, even when the processing device executes the same inference operation as a different task set, while the runtime may vary, a same result may be obtained. Although the execution process (e.g., the runtime) of an inference operation may vary depending on the task set executed by the processing device, the execution result (e.g., an output of the inference operation) of the inference operation may be the same. Thus, the task set may also be referred to as an “inference path.”

The electronic device may obtain the reference task set using the deep learning compiler. The reference task set may be predicted to have a minimum runtime among possible task sets for instructions for inference operations of the deep learning model. The reference task set may be referred to as a reference path, or may be referred to herein as an optimized path since the reference task set may have a minimum runtime.

In operation 120, the electronic device may determine an additional task set based on the obtained reference task set. The additional task set may refer to a task set in which at least a portion of optimization of instructions performed on the reference task set is released. The additional task set may also be referred to herein as an additional path.

When the processing device executes the first inference operation as a different task set (e.g., the reference task set) and the second inference operation as the additional task set in multi-processes, the additional task set may indicate a task set with a lowered level of optimization than the reference task set in order to reduce the runtime of the first inference operation. The runtime of the second inference operation executed as the additional task set may be greater than the runtime of the second inference operation executed as the reference task set. As described above, when the processing device executes an inference operation as the additional task set, the runtime may be different from when the inference operation is executed as the reference task set, but operations executed (and a result of the execution) may be the same in both cases when the inference operation is executed as the reference task set and as the additional task set.

When the processing device executes the first inference operation and the second inference operation as the reference task set (e.g., the optimized path) in multi-processes, the first inference operation and the second inference operation may require the same amount of time as a first runtime. The first inference operation may have a deadline that precedes the end of the first runtime, and the second inference operation may have no deadline (e.g., no deadline). The processing device may execute the first inference operation as the reference task set and the second inference operation as the additional task set in multi-processes, so the first inference operation may take a second runtime that is less than the first runtime, and the second inference operation may take a third runtime that is greater than the second runtime.

For example, the electronic device may initially determine the reference task set as the additional task set. As described below, the electronic device may repeatedly adjust the additional task set and may determine the additional task set when a predicted runtime based on the additional task set meets a target runtime.

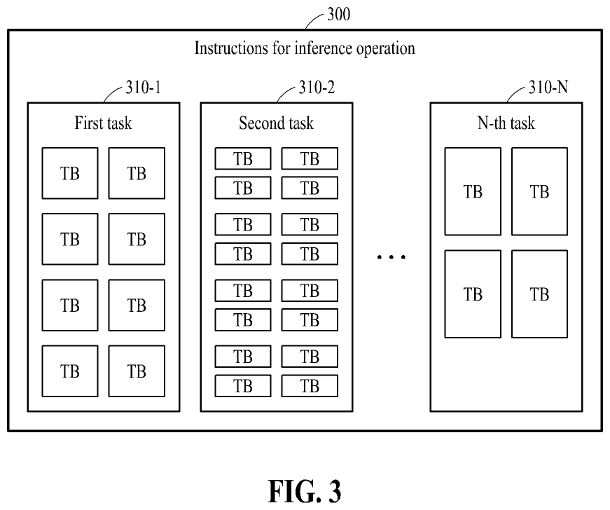

For example, the electronic device may determine a result of adjusting the reference task set as the additional task set. The electronic device may determine a result of changing at least a portion of instructions, which has partitioned at least one task among tasks included in the reference task set or performed instruction insertion or operation fusion cancelation on the at least one task, as the additional task set. As described below with reference to FIGS. 3 to 7, adjusting the task set (e.g., the reference task set or the additional task set) may include partitioning at least one task or performing instruction insertion or operator fusion cancelation on at least one task.

In operation 130, the electronic device may determine a predicted runtime of at least one inference operation among the first inference operation or the second inference operation when the processing device executes, through multi-processes, the first inference operation and the second inference operation in parallel as the reference task set and the additional task set.

A runtime of an inference operation may be a length of time from a start time of the inference operation to a completion time of the inference operation. For example, the electronic device may predict at least one of a first length of time, which may be from a start time of the first inference operation to a completion time of the first inference operation, or a second length of time, which may be from a start time of the second inference operation to a completion time of the second inference operation.

The electronic device may predict the runtime of one of the first inference operation and the second inference operation that has been executed as the reference task set. As described above, when a given inference operation among inference operations is executed as the reference task set and the other inference operation is executed as the additional task set, the runtime of the inference operation executed as the reference task set may decrease and the runtime of the inference operation executed as the additional task set may increase compared to a case in which each of the inference operations are executed as the reference task set. The electronic device may predict the runtime of the inference operation executed as the reference task set in order to determine whether the runtime of the inference operation executed as the reference task set may meet the deadline.

The electronic device may determine, as the predicted runtime, a runtime measured after the processing device actually executes the first inference operation and the second inference operation in parallel as the reference task set and the additional task set through multi-processes. Predicting of the runtime by the processing device using actual execution results may be referred to herein as runtime prediction through profiling (e.g., compiler profiling).

The electronic device may predict the runtime of an inference operation using a task-specific model that models a runtime for each task and/or a model for each task combination that models a runtime of a task combination of tasks. The task-specific model or the model for each task combination may be built using linear regression.

In operation 140, the electronic device may adjust the determined additional task set in response to the predicted runtime exceeding a target runtime set for at least one inference operation.

The target runtime may be a value set as a goal of a runtime for an additional task set. For example, when the processing device performs inference operations in parallel, the target runtime may indicate a permissible range of an increased runtime of at least one of the inference operations, that is, of an increased runtime compared to a reference runtime. The reference runtime may be a runtime required for a processing device to perform a single inference operation as the reference task set through a single process.

For example, the electronic device may determine the reference runtime through the profiling and/or the model described above in operation 130. The electronic device may obtain the target runtime indicating a permissible range of a runtime increased compared to the reference runtime based on the reference runtime and a target ratio. The target ratio may have a value greater than “1” and less than “2”, for example. The electronic device may obtain a target ratio of “1.5.” The electronic device may obtain the target runtime (e.g., 1.5 times the reference runtime) by multiplying the reference runtime by the target ratio of “1.5.”

The electronic device may adjust the additional task set or map the additional task set to the target runtime (i.e., associate the additional task with the target runtime) based on a result of comparing the predicted runtime to the target runtime. For example, the electronic device may adjust the additional task set when the predicted runtime exceeds the target runtime. The predicted runtime (e.g., the runtime of an additional operation executed as the reference task set) exceeding the target runtime may indicate that the additional task set has not yet met the target runtime. Consequently, the electronic device may further degrade/reduce the optimization level (e.g., as performed by the compiler) of the additional task set to reduce the predicted runtime.

For example, the electronic device may select a task having a longest runtime from among tasks included in the additional task set. The runtime of a task may, similarly to the runtime of an inference operation, refers to a length of time from a start time of the task to a completion time of the task. Similar to predicting a runtime of an inference operation, the electronic device (e.g., the compiler) may determine the runtime of a task using profiling or a model (e.g., the task-specific model or the model for each task combination).

The electronic device may perform one of task partitioning or operator fusion cancelation (or instruction insertion) based on a result of comparing a number of thread blocks (TBs) included in a selected task to a number of TBs that may be simultaneously executed by the processing device. A TB may refer to a unit that divides instructions or operations included in each task. The TB is described with reference to FIG. 3.

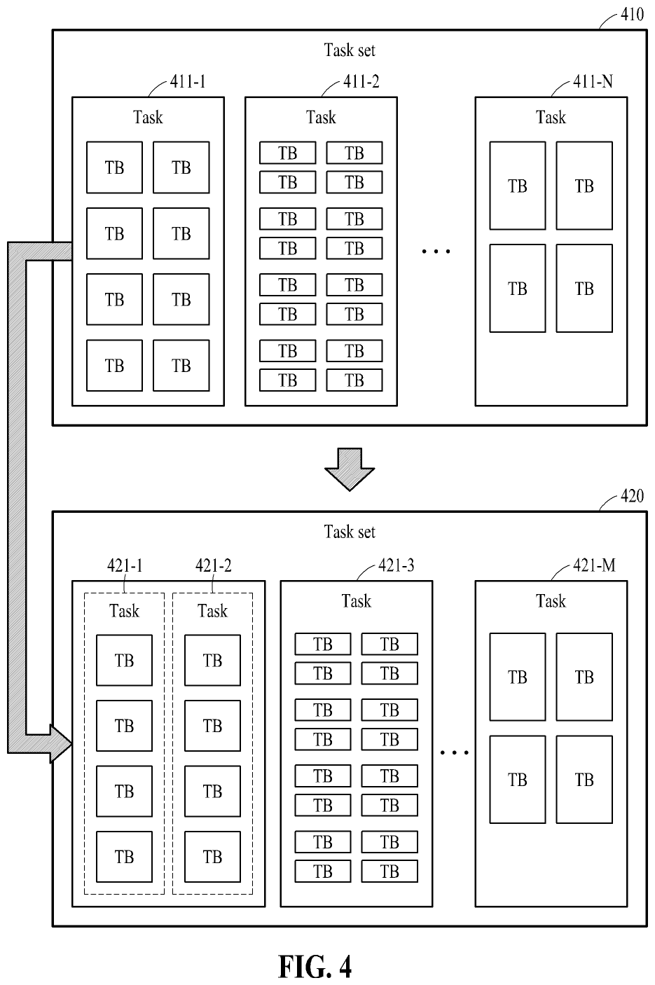

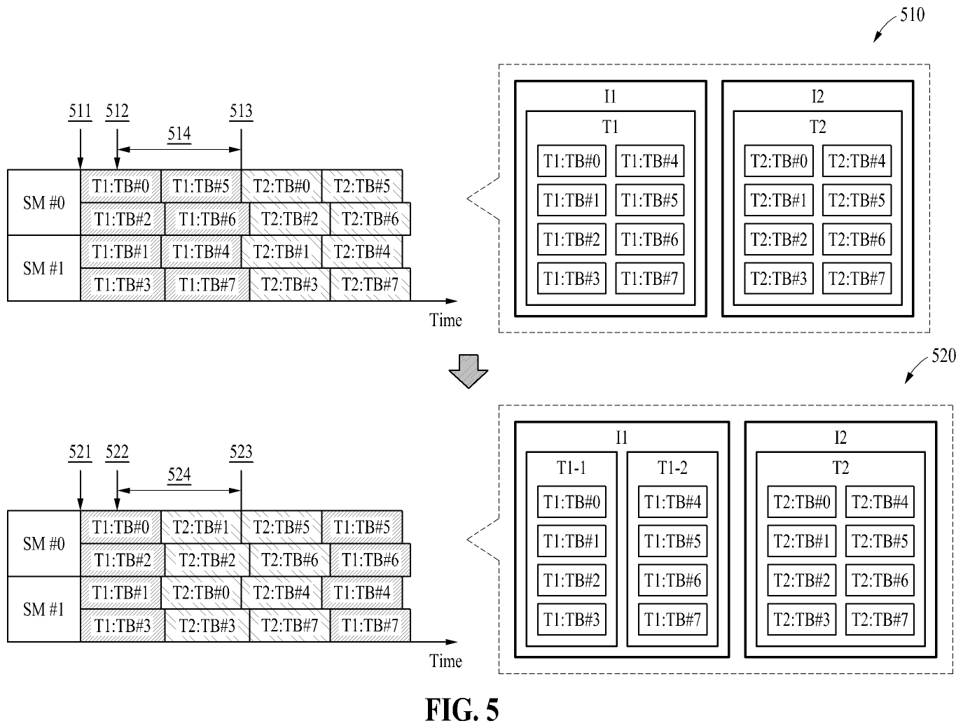

The electronic device may perform partitioning of the selected task in response to the number of TBs included in the selected task exceeding the number of TBs that may be simultaneously executed by the processing device. Task partitioning is described with reference to FIGS. 4 and 5.

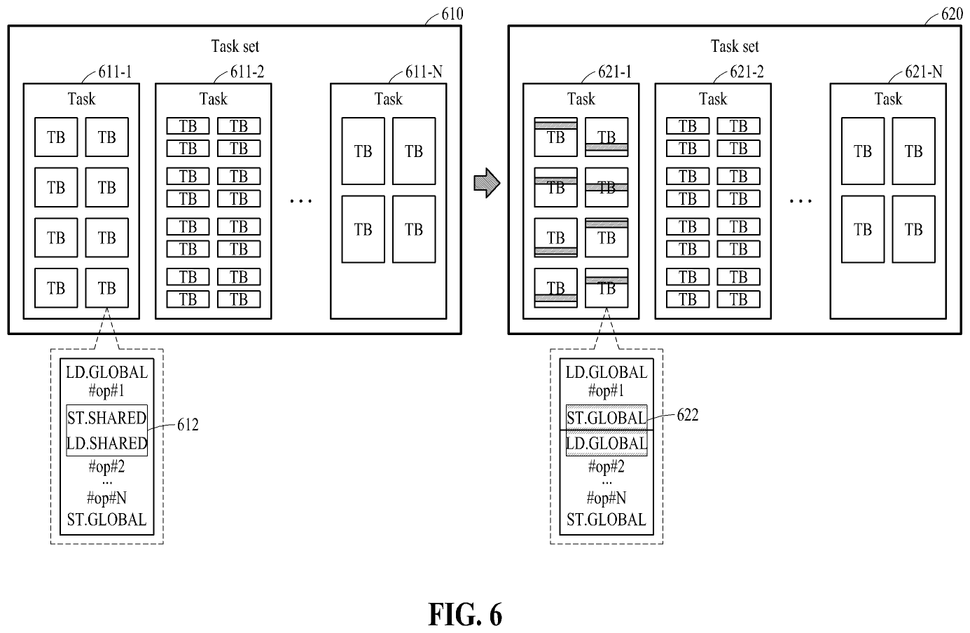

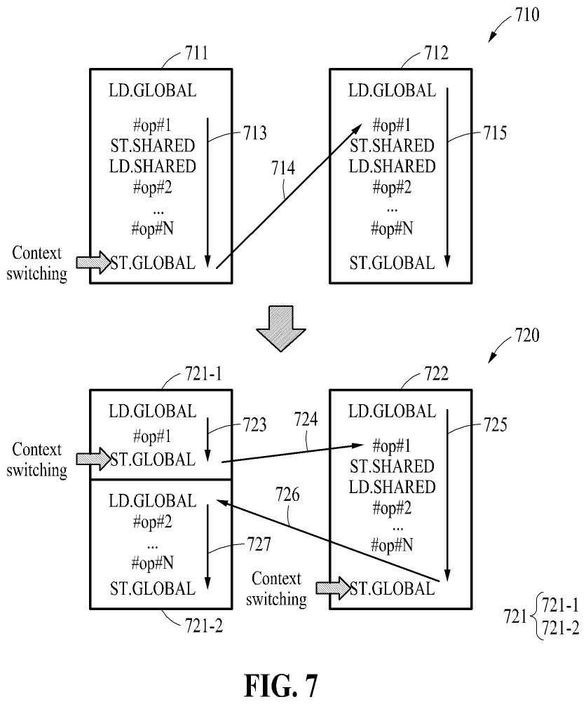

The electronic device may perform instruction insertion or operator fusion cancelation on the selected task in response to the number of TBs included in the selected task being less than or equal to the number of TBs that may be simultaneously executed by the processing device. Performing instruction insertion or operator fusion cancelation on a task is described with reference to FIGS. 6 and 7.

In operation 150, the electronic device may map the determined additional task set to the target runtime (i.e., associate it with the target runtime) based on the predicted runtime being less than or equal to the target runtime. The predicted runtime (e.g., the runtime of an additional operation executed as the reference task set) being less than or equal to the target runtime may indicate that the additional task set has met the target runtime. Accordingly, the electronic device may determine the current additional task set as a task set for the target runtime and complete adjustment of the additional task set.

The electronic device may obtain inference requests after determining the additional task set.

For example, the electronic device may obtain a first inference request, a second inference request, and a deadline for the first inference request. Each inference request (e.g., the first inference request or the second inference request) may indicate a request to perform an inference operation on a deep learning model. Each inference request may include an input value of input data of the deep learning model. A priority of the first inference request may be higher than a priority of the second inference request. A deadline (e.g., required finish time) for the first inference request may be set, and a deadline for the second inference request may not exist. For example, the deadline for the first inference request may be obtained as the target ratio (e.g., 1.5 or 150%) to the reference runtime.

When the target runtime meets the obtained deadline, the electronic device may cause the processing device to execute, through multi-processes, an inference operation corresponding to the first inference request as the reference task set and an inference operation corresponding to the second inference request as the additional task set. For example, the electronic device may transmit, to the processing device, information indicating that the reference task set is to be assigned to the first inference request and the additional task set to the second inference request. The processing device may execute, through multi-processes, an inference operation corresponding to the first inference request as the reference task set and an inference operation corresponding to the second inference request as the additional task set. Consequently, the processing device may complete the execution of the inference operation corresponding to the first inference request within the deadline.

The electronic device may control the execution of inference operations performed by the processing device through multi-processes by changing a task set that separates instructions corresponding to the inference operations, without changing the scheduler of the processing device.

FIG. 2 illustrates an example of obtaining a reference task set and an additional task set, according to one or more embodiments. The operations of FIG. 2 are performed by an electronic device or computing device, an example of which is described with reference to FIG. 10.

Referring to FIG. 2, the electronic device may obtain information on a deep learning model 210. The deep learning model 210 may be a neural network built using a deep learning framework. The electronic device may obtain, from the information on the deep learning model 210, instructions (e.g., machine code, object code, etc.) for performing operations corresponding to performance of an inference operation by the deep learning model 210. The information on the deep learning model 210 may include information on a layer, node, edge, parameter, and/or weight of the deep learning model 210. The instructions may also be described herein as being obtained from the deep learning model 210.

In operation 220, the electronic device may import the deep learning model 210 into a deep learning compiler.

In operation 230, the electronic device may compile the deep learning model 210 using the deep learning compiler. Compiling the deep learning model 210 may include (i) determining operations for performing the inference operation of the deep learning model 210 (from the information on the deep learning model 210) and (ii) generating instructions corresponding to the operations.

Regarding determining, from the deep learning model 210, the operations corresponding to the inference operation of the deep learning model 210, the operations corresponding to the inference operation may also involve determining a computation graph. The computation graph may represent the operations corresponding to the inference operation of the deep learning model 210. That is to say, the computation graph may be a representation of inference computation of the deep learning model 210.

In operation 231, the electronic device may perform operator fusion for the determined operations (e.g., on the computation graph). Initially, each operation may trigger: (i) an operation of obtaining (e.g., loading) an input value from device memory (e.g., global memory), (ii) an operation of determining an output value by applying an operation to the input value, and (iii) an operation of storing the output value in the device memory.

For example, the inference operation of the deep learning model 210 may include performing a first operation and subsequently performing a second operation. A first operator (corresponding to the first operation) may be fused with a second operator (corresponding to the second operation) into one operator, which may involve replacing an operation of accessing (e.g., loading or storing in) the device memory with an operation of accessing shared memory (e.g., cache memory) between the first operation and the second operation. That is to say, a load/store used to link the first operation and the second operation may be replaced with a shared memory access.

The shared memory may have a shorter access time than the device memory. When the operation of accessing the device memory is replaced with the operation of accessing the shared memory, the operations of the inference operation may be performed more efficiently (e.g., with less runtime). Operator fusion may also be referred to herein as computation graph optimization.

The electronic device may generate operator fusion information while performing operator fusion. As described with reference to FIGS. 6 and 7, the electronic device may perform operator fusion cancelation using the operator fusion information.

In operation 232, the electronic device deep learning compiler may generate instructions (e.g., source code) corresponding to each operator. To elaborate, the electronic device may generate source code for a program corresponding to the inference operation of the deep learning model 210, and part of the source code may include the instructions (source code portions) corresponding to each operator. The electronic device may divide the instructions corresponding to the inference operation of the deep learning model 210 into tasks and/or threadblocks (TBs) in consideration of the hardware specification of the processing device. Instruction generation may also be referred to herein as hardware-specific optimization.

Although not shown in FIG. 2, the electronic device (the deep learning compiler) may generate task information while performing instruction generation. As described with reference to FIGS. 4 and 5, the electronic device may perform task partitioning using the task information.

The electronic device may obtain a deep learning model description 240 as a result of compiling the deep learning model 210. The deep learning model description 240 may include operators corresponding to the inference operation of the deep learning model 210 and the instructions corresponding to each operator. The deep learning model description 240 may include a reference task set, which may be a result of dividing instructions corresponding to the inference operation of the deep learning model 210 into tasks.

Although an operation of obtaining the deep learning model description 240 from the information on the deep learning model 210 is mainly described as being performed by the electronic device, examples are not limited thereto. For example, an external device separate from the electronic device may generate the deep learning model description 240 by compiling the deep learning model 210 using the deep learning compiler. The external device may transmit a result (e.g., task information, operator fusion information, the deep learning model description 240, or the reference task set) of compiling the deep learning model 210 to the electronic device. The electronic device may determine an additional task set through the operations described above with reference to FIG. 1 based on the received result of compiling the deep learning model 210.

In operation 250, the electronic device may obtain the reference task set. As described above, the reference task set may include the result of compiling obtained through the deep learning compiler.

In operation 260, the electronic device may obtain the additional task set. For example, the additional task set may initially be the reference task set.

In operation 270, the electronic device may determine whether the additional task set meets a target runtime. As described above with reference to FIG. 1, when the processing device executes inference operations in multi-processes based on the reference task set and the additional task set, the electronic device may predict/estimate the runtime of an inference operation performed as the reference task set. When the predicted/estimated runtime is less than or equal to the target runtime, the electronic device may determine that the additional task set meets the target runtime. When the predicted runtime exceeds the target runtime, the electronic device may determine that the additional task set does not meet the target runtime.

In operation 280, the electronic device may adjust the additional task set when the additional task set does not meet the target runtime. The electronic device may update the predicted runtime based on the adjusted additional task set. The electronic device may compare the updated predicted runtime to the target runtime. The electronic device may repeat adjusting the additional task set and updating the predicted runtime as long as the updated predicted runtime exceeds the target runtime.

In operation 290, when the additional task set meets the target runtime, the electronic device may (i) map the additional task set to the target runtime (e.g., store an association of the additional task set and its target runtime), and (ii) stop adjusting the additional task set and updating the predicted runtime.

FIG. 3 illustrates an example of a result of dividing instructions for an inference operation into tasks, according to one or more embodiments.

Instructions 300 for an inference operation may be divided into multiple tasks. As described above, a task may be an execution unit of a processing device. Referring to FIG. 3, for example, the instructions 300 for an inference operation may be divided into “N” tasks (e.g., a first task 310-1, a second task 310-2, . . . , and an N-th task 310-N).

Each task may be divided into TBs. As described above, a TB may be a unit that of instructions or operations included in each task. Multiple TBs included in one task may have similar resource requirements and similar runtimes. The TBs included in a given task may be executed in parallel as an operation set (or a set of instructions) where each TB is independent of each other TB.

Resource requirements or runtimes of TBs included in different tasks may be independent of each other (requirements/runtimes of TBs a task may be independent of requirements/runtimes in another task). For example, a TB of the first task 310-1 and a TB of the second task 310-2 may have different respective resource requirements and/or different runtimes.

As described above with reference to FIG. 1, when adjusting the additional task set, the electronic device may determine a number of TBs that may be simultaneously executed by the processing device to select between task partitioning and operator fusion cancelation (or instruction insertion). The number of TBs that may be simultaneously executed may be determined by according to the resource requirements of the TBs of the task. For example, according to resource requirements, the number of TBs that may be simultaneously executed by the processing device may be determined to be “4” for the first task 310-1 and may be determined to be “8” for the second task 310-2.

Each TB may include threads, and each TB may include at least one warp. Each warp may include a preset number (e.g., 32) of threads. For example, when one TB includes 64 threads, that TB may include two warps.

FIG. 4 illustrates an example of an operation of partitioning a task, according to one or more embodiments.

The electronic device may adjust an additional task set by partitioning at least one task included in the additional task set.

The electronic device may determine (e.g., predict) a runtime of each task included in the additional task set. When executing a first inference operation as a reference task set and a second inference operation as the additional task set through multi-processes, a runtime of each task of the second inference operation may be determined (e.g., predicted).

A task with a longest runtime may be selected from among tasks included in the additional task set. The selected task may be partitioned into multiple tasks. For example, the selected task may be partitioned into a first task and a second task, where the first task includes at least one TB among TBs included in the selected task, and where the second task includes the remaining TBs among the TBs included in the selected task. An additional task set may be determined in which the selected task from the reference task set is replaced with multiple tasks.

Regarding the partitioning of a task, partitioning the selected task into two tasks is mainly described herein, but examples are not limited thereto. For example, the selected task may be partitioned into three or more tasks.

Referring to FIG. 4, a task set 410 may be adjusted. The task set 410 may include, e.g., a task 411-1, a task 411-2, . . . , and a task 411-N. The task 411-1 may be selected as having a longest runtime from among the tasks. For example, the selected task 411-1 may include eight TBs. The task 411-1 may be partitioned into a task 421-1 including four TBs and a task 421-2 including the other four TBs. The task set 420 may be obtained by replacing the task 411-1 in the task set 410 with the task 421-1 and the task 421-2.

For each task among tasks included in the reference task set, task information related to execution of the corresponding task may be obtained using a deep learning compiler. The task information of a task may include, for example, a register usage, a shared memory usage, a number of TBs, and/or block occupancy of a processing device. The block occupancy may be the number of TBs that the processing device may execute simultaneously. The selected task may be partitioned into multiple tasks based on the task information of the tasks.

For example, the selected task including “N” TBs may be partitioned into “K” tasks based on the task information (“N” and “K” may each be greater than or equal to “2”). The electronic device may partition the selected task into tasks that include a number (e.g., N/K raised, rounded down, or rounded) based on a value obtained by dividing “N” by “K” (e.g., N/K).

For example, the selected task including “N” TBs may be partitioned into tasks having a preset number (e.g., “P”) of TBs (“N” and “P” may each be greater than or equal to “2”). The selected task may be partitioned into “K−1” task(s) (each including “P” TBs) and a task including “N−(K−1)*P” TBs.

For example, “P” may be determined to be a number of (and/or multiple of) TBs that the processing device may efficiently process through multi-processes. For example, “P” may be determined to be a value obtained by multiplying the block occupancy of the processing device by a number of streaming multiprocessors of the processing device together and/or a multiple of the value. For example, “P” may be determined as a value multiplied by the number of streaming multiprocessors of the processing device and/or as a multiple of this value.

FIG. 5 illustrates an example of an operation, performed by a processing device, of executing inference operations according to task partitioning, according to one or more embodiments.

The processing device may include multiple streaming multiprocessors (marked as “SM” in FIG. 5). For example, the processing device may include a first streaming multiprocessor SM #0 and a second streaming multiprocessor SM #1. The processing device may execute the inference operations through multi-processes.

A reference task set of an inference operation may include one task of eight TBs, for example. In practice, most task sets (e.g., the reference task set or the additional task set) into instructions corresponding to a deep learning inference operation are divided may include multiple tasks. However, for ease of description, an example reference task set of a deep learning inference operation including one task is described with reference to FIG. 5.

In a first execution 510, the processing device may execute a first inference operation I1 and a second inference operation I2 as a reference task set in multi-processes. The reference task set of the first inference operation I1 may include a first task T1. The first task T1 may include TBs of the first task T1 (e.g., T1:TB #0 to T1:TB #7). The reference task set of the second inference operation 12 may include a second task T2. The second task T2 may include TBs of the second task T2 (e.g., T2:TB #0 to T2:TB #7).

The processing device may insert the first task T1 of the first inference operation I1 into a task queue at a time point 511. The processing device may execute the first task T1 inserted into the task queue, in response to an existence of resources in an idle state (e.g., the first streaming multiprocessor SM #0 and the second streaming multiprocessor SM #1). The processing device may then execute the TBs included in the first task T1. More specifically, the processing device may allocate, among the eight TBs of the first task T1, four TBs (e.g., T1:TB #0 to T1:TB #3) to the first streaming multiprocessor SM #0 and the second streaming multiprocessor SM #1 in an idle state and set a state of the other four TBs (e.g., T1:TB #4 to T1:TB #7) to a wait state. The processing device may execute the four TBs (T1:TB #0 to T1:TB #3) in parallel.

The processing device may insert the second task T2 of the second inference operation 12 into the task queue at a time point 512. The processing device may wait for an execution of the second task T2 based on a while there are no resources in an idle state.

The processing device (e.g., a scheduler) may execute the TBs in the wait state before executing the TBs of the task included in the task queue. Referring to FIG. 5, the processing device may execute the TB in the wait state (e.g., the TB T1:TB #4) among the first task T1 in response to completion of an execution of at least one TB (e.g., the TB T1:TB #1) among the four executing/executed TBs. When the electronic device starts the execution of the TB in the wait state, the electronic device may release the wait state of the TB. As execution of the other four TBs (e.g., T1:TB #4 to T1:TB #7) starts, there may no longer be a TB in the wait state.

The processing device may execute a task out of the task queue when there is no TB in the wait state and when an execution of at least one TB is completed. Referring to FIG. 5, for example, when an execution of the thread block T1:TB #5 is completed, the electronic device may obtain the second task T2 from the task queue at a time point 513. The electronic device may execute TBs of the second task T2 (e.g., T2:TB #0 to T2:TB #7). Consequently, the electronic device may execute the second inference operation I2 after waiting for a time length 514 from the time point 512 to the time point 513.

In a second execution 520, the processing device may execute the first inference operation I1 as the additional task set and the second inference operation I2 as the reference task set in multi-processes. As shown in FIG. 5, for example, the additional task set may include a result of partitioning the first task T1 into two tasks (e.g., a task T1-1 and a task T1-2).

The processing device may insert the task T1-1 of the first inference operation I1 into the task queue at a time point 521. The processing device may execute the task T1-1 inserted into the task queue, in response to detection of idle resources (e.g., the first streaming multiprocessor SM #0 and the second streaming multiprocessor SM #1). The processing device may execute the TBs included in the task T1-1 (e.g., T1:TB #0 to T1:TB #3). More specifically, the processing device may allocate the four TBs (T1:TB #0 to T1:TB #3) of the task T1-1 to the first streaming multiprocessor SM #0 and the second streaming multiprocessor SM #1 (both in an idle state). The processing device may execute the four TBs (T1:TB #0 to T1:TB #3) in parallel.

The processing device may insert the second task T2 of the second inference operation I2 into the task queue at a time point 522. The processing device may wait for the execution of the second task T2 until there are resources in an idle state.

Furthermore, the processing device (e.g., the scheduler) may execute the TBs in the wait state before executing the TBs of the task included in the task queue. Unlike in the first execution 510, however, in the second execution 520, the task T1-1 of the first inference operation I1 may include the four TBs (T1:TB #0 to T1:TB #3) and accordingly, there may not be a TB in the wait state. Consequently, in the second execution 520, the processing device may obtain the second task T2 from the task queue in response to completion of at least one TB (e.g., the TB T1:TB #1) of the four TBs, execute one TB (e.g., T2:TB #0) among the TBs of the second task T2, and set the state of the other TBs (e.g., T2:TB #1 to T2:TB #7) to the wait state.

The processing device may execute the TBs (T2:TB #1 to T2:TB #7) of the second task T2 in the wait state before executing the task T1-2. The processing device may execute the task T1-2 after the execution of all of the TBs T2:TB #1 to T2:TB #7 has started.

Consequently, the electronic device may execute the second inference operation I2 after waiting for a time length 524 from the time point 522 to a time point 523. Consequently, the second inference operation I2 (executed as the reference task set) may be executed during a shorter runtime in the second execution 520 (in which the first inference operation I1 is executed as the additional task set) than in the first execution 510 (in which the first inference operation I1 is executed as the reference task set).

FIG. 6 illustrates an example of operator fusion cancelation or command insertion, according to one or more embodiments.

The electronic device may adjust the additional task set by inserting an instruction into at least one task included in the additional task set or canceling operator fusion in at least one task.

A task may be selected as having a longest runtime from among tasks included in the additional task set. A changed task may be obtained by inserting an instruction that causes context switching in the selected task. For example, the instruction that causes context switching may be inserted into each of TBs included in the selected task. An additional task set may be determined in which the selected task is replaced with the thus-changed task. A portion of the instructions included in the task may be replaced with the instruction that causes context switching.

A scheduler of the processing device may allocate TBs to a same resource (e.g., a streaming multiprocessor) and execute those TBs while interleaving the TBs. For example, the scheduler of the processing device may allocate a first TB and a second TB to a determined processing element. The determined processing element of the processing device may execute the first TB and suspend an execution of the second TB. When the instruction causing context switching is executed in the first TB, the determined processing element may suspend execution of the first TB and execute the second TB.

By inserting the instruction causing context switching in a task included in the additional task set, there may be an increase in the probability of conversion from an inference operation executed as the additional task set to another inference operation (e.g., an inference operation executed as the reference task set) executed in parallel.

The instruction causing context switching may be, for example, an instruction that directs an operation of accessing device memory (e.g., an operation of loading a value from global memory, or an operation of storing a value in global memory). Insertion of the instruction may cause context switching into a task by canceling operator fusion performed on the task. As described above, operator fusion involve replacing an operation of accessing the device memory with an operation of accessing shared memory between related operations. Operator fusion cancelation may involve replacing (e.g., restoring) an operation of accessing the shared memory with an operation of accessing the device memory.

For example, the electronic device may, regarding operator fusions performed using a deep learning compiler, obtain operator fusion information including information on a gain of each operator fusion and on operators before and after each operator fusion. The gain of operator fusion involve a reduction in the runtime required to execute instructions of the operator after operator fusion, as compared to the runtime required to execute instructions corresponding to the operators before the operator fusion. Based on the obtained operator fusion information, cancellation of operator fusion having a least gain among operator fusions may be performed in each TB included in the selected task.

Referring to FIG. 6, a task set 610 may be adjusted. The task set 610 may include tasks (e.g., a task 611-1, a task 611-2, . . . , and a task 611-N). The task 611-1 may be selected as having the longest runtime from among the tasks. For example, the selected task 611-1 may include eight TBs. A task 621-1 may be obtained by inserting the instruction causing context switching into each TB included in the task 611-1.

Instructions 612 accessing the shared memory may be replaced with instructions 622 accessing the device memory, which may be done in each TB of the task 611-1. For example, an operation of accessing the shared memory may be replaced with an operation of accessing the device memory between operations corresponding to a first operator (e.g., #op #1) and a second operator (e.g., #op #2), which may be done by canceling operator fusion performed on the first operator (e.g., #op #1) and the second operator (e.g., #op #2).

A task set 620 may be obtained in which the task 611-1 of the task set 610 is replaced with the task 621-1 as a result of adjusting the task set 610.

FIG. 7 illustrates an example of executing inference operations according to operator fusion cancelation, according to one or more embodiments.

The processing device may allocate two TBs to a processing element (e.g., a streaming multiprocessor). The processing element may execute one TB among TBs and, in response to an execution of code that causes context switching included in the one TB in execution, suspend the execution of the one TB and execute another TB.

In an execution 710, a TB 711 and a TB 712 may include same operations in different inference operations. The TB 711 may be part of instructions for a first inference operation, and the TB 712 may be part of instructions for a second inference operation. The TB 711 and the TB 712 represent TBs in a case in which both the first inference operation and the second inference operation are executed as the reference task set.

In the execution 710, the processing device may allocate the TB 711 and the TB 712 to the processing element. The processing element may execute the TB 711 and the TB 712 while interleaving the TB 711 and the TB 712. The processing element may, in response to executing an instruction causing context switching of the TB 711 (e.g., an instruction, marked as LD GLOBAL in FIG. 7, that directs an operation of loading a value from global memory), perform context switching from the TB 711 to the TB 712. Thereafter, the processing element may, in response to executing an instruction causing context switching of the TB 712 (e.g., an instruction, marked as LD GLOBAL in FIG. 7, that directs an operation of loading a value from global memory), perform context switching from the TB 712 to the TB 711.

In an execution process 713, the processing element may sequentially execute instructions included in the TB 711. Thereafter, the processing element may execute the instruction causing context switching (e.g., an operation of storing a value in global memory, which is marked as ST.GLOBAL in FIG. 7) included in the TB 711. In an execution process 714, the processing element may perform context switching from the TB 711 to the TB 712 in response to an execution of the instruction causing context switching. In an execution process 715, the processing element may sequentially execute instructions included in the TB 712.

In an execution 720, a TB 721 and a TB 722 may correspond to the TB 711 and the TB 712, respectively. The TB 721 may be a thread block of an additional task set in which operator fusion cancelation or instruction insertion is performed in the TB 711 of the reference task set.

In the execution 720, the processing device may allocate the TB 721 and the TB 722 to the processing element. As in the execution 710, the processing element may execute the TB 721 and the TB 722 while interleaving the TB 721 and the TB 722. The processing element may, in response to executing an instruction causing context switching of the TB 721 (e.g., an instruction, marked as LD GLOBAL in FIG. 7, that directs an operation of loading a value from global memory), perform context switching from the TB 721 to the TB 722. Thereafter, the processing element may, in response to executing an instruction causing context switching of the TB 722 (e.g., an instruction, marked as LD GLOBAL in FIG. 7, that directs an operation of loading a value from global memory), perform context switching from the TB 722 to the TB 721.

In an execution process 723, the processing element may sequentially execute a portion 721-1 of instructions included in the TB 721. Next, the processing element may execute an instruction causing context switching (e.g., an operation of storing a value in global memory, which is marked as ST.GLOBAL in FIG. 7, and an operation of loading a value from global memory, which is marked as LD.GLOBAL in FIG. 7) included in the TB 721. In an execution process 724, the processing element may perform context switching from the TB 721 to the TB 722 in response to execution of the instruction causing context switching. In an execution process 725, the processing element may sequentially execute instructions included in the TB 722. The processing element may execute an instruction causing context switching (e.g., an operation of loading a value from global memory, which is marked as LD.GLOBAL in FIG. 7) included in the TB 722. In an execution process 726, the processing element may perform context switching from the TB 722 to the TB 721 in response to execution of the instruction causing context switching. In an execution process 727, the processing element may sequentially execute the other instructions 721-2 included in the TB 721.

Consequently, the processing device may execute the TB 722 in the execution 720 with a less runtime than when executing the TB 712 in the execution 710.

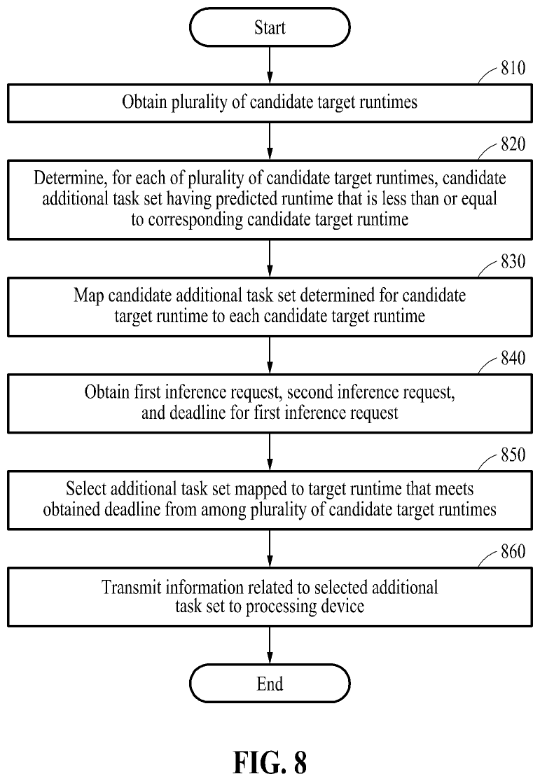

FIG. 8 illustrates an example of obtaining additional task sets corresponding to candidate target runtimes and selecting a task set for an inference request, according to one or more embodiments.

In operation 810, candidate target runtimes may be obtained. For example, candidate target ratios may be obtained. The candidate target runtimes may be obtained by applying each target ratio to a reference runtime. For example, the candidate target ratios may include 1.1, 1.2, 1.33, and 1.5.

In operation 820, for each of the candidate target runtimes, a candidate additional task set may be obtained that has a predicted runtime that is less than or equal to a corresponding candidate target runtime. As described above, the predicted runtime may be a time predicted as a runtime of a first inference operation when the processing device executes the first inference operation as the reference task set and a second inference operation as the candidate additional task set through multi-processes. The operation of determining a candidate additional task set for each candidate target execution time may be performed the same as or similar to the operation of determining the additional task set described with reference to FIGS. 1 to 7.

In operation 830, the candidate additional task set determined for the candidate target runtime may be mapped to each candidate target runtime. A candidate additional task set that meets a corresponding candidate target runtime may be mapped to each candidate target runtime.

In operation 840, candidate additional task sets mapped to candidate target runtimes may be determined and a first inference request, a second inference request, and a deadline for the first inference request may be obtained.

The deadline for the first inference request may be obtained as a limit ratio to the reference runtime. For example, the limit ratio may be 1.5, and the deadline for the first inference request may be obtained at 1.5 times the reference runtime.

In operation 850, the additional task set mapped to the target runtime that meets the obtained deadline may be selected from among the candidate target runtimes. The target runtime that meets the deadline may be selected from among the candidate target runtimes. The target runtime meeting the deadline may indicate that the target runtime is less than or equal to a runtime determined by the deadline. The additional task set mapped to the selected target runtime may be selected from among candidate additional task sets.

When candidate target runtimes meet a deadline, a longest candidate target runtime may be selected from among the candidate target runtimes; the longest candidate target runtime may be selected as meeting the deadline as the target runtime. For example, when the limit ratio is 1.5, target ratios of 1.1, 1.2, 1.33, and 1.5 may all meet the candidate target runtimes. A candidate target runtime corresponding to the target ratio of 1.5 may be selected as the target runtime. A candidate additional task set mapped to a target runtime that is 1.5 times the reference runtime may be selected as the additional task set.

In operation 860, information related to the selected additional task set may be transmitted to the processing device. The electronic device may cause the processing device to process an inference operation corresponding to the first inference request as the reference task set and to process an inference operation corresponding to the second inference request as the selected additional task set through multi-processes.

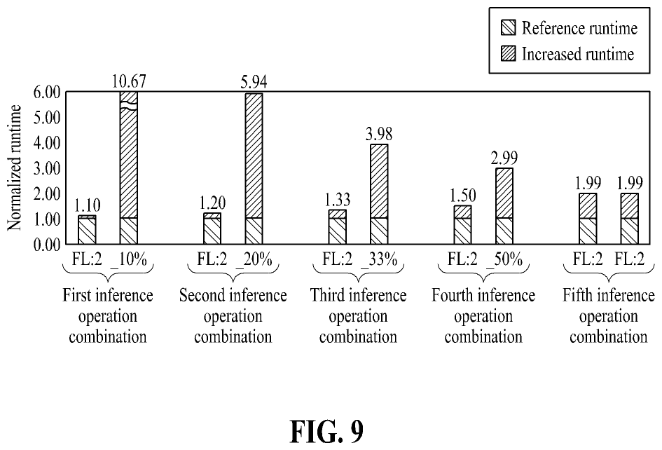

FIG. 9 illustrates example runtimes of inference operations in a case in which a processing device executes inference operations in multi-processes using an additional task set mapped to various target runtimes, according to one or more embodiments.

Referring to FIG. 9, the inference operation combinations in the graph show runtimes of inference operations when the processing device executes one of two inference operation as the reference task set and the other inference operation as the additional task set. Exceptionally, a fifth inference operation combination represents the runtime of each inference operation when the processing device executes two inference operations as a reference task set through multi-processes. In the graph, the runtime of each inference operation appears as a normalized value with respect to the reference runtime (e.g., the runtime divided by the reference runtime).

In a first inference operation combination, the target runtime of the additional task is set to be 1.1 times the reference runtime. In a second inference operation combination, the target runtime of the additional task is set to be 1.2 times the reference runtime. In a third inference operation combination, the target runtime of the additional task is set to be 1.33 times the reference runtime. In a fourth inference operation combination, the target runtime of the additional task is set to be 1.5 times the reference runtime.

Referring to FIG. 9, FL:2 is the inference operation executed as the reference task set, and _10%, _20%, _33%, and _50% respectively indicate an inference operation executed as: an additional task set corresponding to a target runtime of 1.1 times the reference runtime; an inference operation executed as an additional task set corresponding to a target runtime of 1.2 times the reference runtime; an inference operation executed as an additional task set corresponding to a target runtime of 1.33 times the reference runtime; and an inference operation executed as an additional task set corresponding to a target runtime of 1.5 times the reference runtime.

FIG. 10 illustrates an example of an electronic device, according to one or more embodiments.

An electronic device 1000 may include an information obtaining portion 1010, a processor 1020, a memory 1030, and a communicator 1040.

The information obtaining portion 1010 may obtain information. For example, the information obtaining portion 1010 may obtain information on a deep learning model and/or information on a reference data set.

The processor 1020 may obtain the reference task set. The processor 1020 may determine an additional task set. The processor 1020 may determine a predicted runtime. The processor 1020 may adjust the additional task set. The processor 1020 may map the additional task set to a target runtime.

The memory 1030 may temporarily and/or permanently store at least one of a deep learning model, a deep learning compiler, the reference task set, the additional task set, or the predicted runtime. The memory 1030 may store instructions for an operation of obtaining the reference task set, an operation of determining the additional task set, and an operation of determining the predicted runtime, an operation of adjusting the additional task set, and/or an operation of mapping the additional task set to a target runtime. However, these are only examples, and information stored in the memory 1030 is not limited thereto.

The communicator 1040 may transmit and receive at least one of a deep learning model, a deep learning compiler, the reference task set, the additional task set, or the predicted runtime. The communicator 1040 may establish a wired communication channel and/or a wireless communication channel with an external device (e.g., the processing device, another electronic device, and a server) and may establish communication with the external device via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the Internet, or a computer network (e.g., a LAN or a wide area network (WAN)).

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or a combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of determining a task set for an inference operation of a neural network model, performed by an electronic device, the method comprising:
applying a compiler to the neural network model to obtain a reference task set, the reference task set representing a result of dividing, by the compiler, instructions for an inference operation of the neural network model into tasks, wherein tasks are execution units of a processing device;
determining an additional task set based on the obtained reference task set;
based on the processing device executing, in parallel through multi-processes, a first inference operation as the reference task set and a second inference operation as the additional task set through multi-processes, determining a predicted runtime of a given inference operation of the first inference operation or the second inference operation;
when the predicted runtime exceeds a target runtime set for the given inference operation, adjusting the determined additional task set; and
when the predicted runtime is less than or equal to the target runtime, associating the determined additional task set with the target runtime.

2. The method of claim 1, further comprising:
obtaining a first inference request, a second inference request, and a deadline for the first inference request; and
based on the target runtime meeting the obtained deadline, causing the processing device to execute, through multi-process, an inference operation corresponding to the first inference request as the reference task set and execute an inference operation corresponding to the second inference request as the additional task set.

3. The method of claim 1, wherein the adjusting of the determined additional task set comprises:
selecting a task having a longest runtime from among tasks included in the additional task set;
partitioning the selected task into a set of tasks; and
determining, among the reference task set, the additional task set in which the selected task is replaced with the set of tasks.

4. The method of claim 3, wherein the partitioning of the selected task into the set of tasks comprises:
partitioning the selected task into a first task comprising a thread block among thread blocks included in the selected task and a second task comprising remaining thread blocks among the thread blocks.

5. The method of claim 3, wherein the partitioning of the selected task into the set of tasks comprises:
obtaining, for each task among tasks included in the reference task set, task information related to execution of the corresponding task, the task information comprising a register usage, a shared memory usage, a number of thread blocks, or block occupancy of the processing device; and
partitioning the selected task into the set of tasks based on task information of the set of tasks.

6. The method of claim 1, wherein the adjusting of the determined additional task set comprises:
selecting a task having a longest runtime from among runtimes of tasks included in the additional task set;
obtaining a changed task by inserting an instruction that causes, in the processing device, context switching into the selected task; and
determining the additional task set in which the selected task is replaced with the changed task.

7. The method of claim 6, wherein the obtaining of the changed task comprises:
inserting an instruction that causes context switching into each of thread blocks included in the selected task.

8. The method of claim 6, wherein the obtaining of the changed task comprises:
regarding operator fusions performed using the compiler, obtaining operator fusion information comprising information on a gain of each operator fusion and on operators before and after each operator fusion; and
canceling operator fusion having a least gain among gains of operator fusions performed in each thread block included in the selected task, based on the obtained operator fusion information.

9. The method of claim 1, wherein the adjusting of the determined additional task set comprises:
selecting a task having a longest runtime from among runtimes of tasks included in the additional task set;
performing partitioning of the selected task based on a number of thread blocks included in the selected task exceeding a maximum number of thread blocks simultaneously executable by the processing device; and
performing instruction insertion or operator fusion cancelation on the selected task based on the number of thread blocks included in the selected task being less than or equal to the maximum number of thread blocks simultaneously executable by the processing device.

10. The method of claim 1, wherein the determining of the additional task set comprises:
determining a result of changing at least a portion of instructions as the additional task set, wherein the portion of instructions has partitioned at least one task among tasks included in the reference task set or has performed instruction insertion or operator fusion cancelation on the at least one task.

11. The method of claim 1, further comprising:
determining a reference runtime required for the processing device to perform, through a single process, a single inference operation as the obtained reference task set; and
obtaining a target runtime indicating a permissible range of a runtime increased compared to the reference runtime based on the reference runtime and a target ratio.

12. The method of claim 1, wherein the determining of the predicted runtime comprises:
predicting a first time length from a start time of the first inference operation to a completion time of the first inference operation or predicting a second time length from a start time of the second inference operation to a completion time of the second inference operation.

13. The method of claim 1, further comprising:
updating the predicted runtime based on the adjusted additional task set;
repeating adjusting the additional task set and updating the predicted runtime based on the updated predicted runtime exceeding the target runtime; and
stopping adjusting the additional task set and updating the predicted runtime, and associating the additional task set with the target runtime, in response to the updated predicted runtime being less than or equal to the target runtime.

14. The method of claim 1, further comprising:
obtaining candidate target runtimes;
determining, for each of the candidate target runtimes, a candidate additional task set having a predicted runtime that is less than or equal to a corresponding candidate target runtime; and
associating the candidate additional task set determined for the candidate target runtime with each candidate target runtime.

15. The method of claim 14, further comprising:
determining candidate additional task sets respectively associated with the candidate target runtimes and subsequently obtaining a first inference request, a second inference request, and a deadline for the first inference request;
selecting an additional task set associated with a target runtime that meets the obtained deadline from among the candidate target runtimes; and
transmitting information related to the selected additional task set to the processing device.

16. The method of claim 15, wherein the transmitting of the information related to the selected additional task set to the processing device comprises:
causing the processing device to process, through multi-processes, an inference operation corresponding to the first inference request as the reference task set and an inference operation corresponding to the second inference request as the selected additional task set.

17. A non-transitory computer-readable storage medium storing instructions that, when executed by a processor, cause the processor to perform the method of claim 1.

18. An electronic device comprising:
one or more processors; and
a memory storing instructions configured to cause the one or more processors to:
apply compiler to a neural network model to obtain a reference task set, the reference task set representing a result of dividing, by the compiler, instructions for an inference operation of the neural network model into tasks, wherein tasks are execution units of a processing device;
determine an additional task set based on the obtained reference task set;
based on the processing device executing, in parallel through multi-processes, a first inference operation as the reference task set and a second inference operation as the additional task set, determine a predicted runtime of a given inference operation of the first inference operation or the second inference operation;
when the predicted runtime exceeds a target runtime set for the given inference operation, adjust the determined additional task set; and
when the predicted runtime is less than or equal to the target runtime, associate the determined additional task set with the target runtime.

19. The electronic device of claim 18, wherein the instructions are further configured to cause the one or more processors to:
select a task having a longest runtime from among tasks included in the additional task set;
partition the selected task into a set of tasks; and
determine, among the reference task set, the additional task set in which the selected task is replaced with the set of tasks.

20. The electronic device of claim 18, wherein the instructions are further configured to cause the one or more processors to:
select a task having a longest runtime from among runtimes of tasks included in the additional task set;
obtain a changed task by inserting an instruction that causes, in the processing device, context switching into the selected task; and
determine the additional task set in which the selected task is replaced with the changed task.
